(19) United States
(12) Patent Application Publication
(10) Pub. No.: US 2024/0331569 A1
(43) Pub. Date: Oct. 3, 2024

(54) KNIFE THROWING TRAINING APPARATUS

(71) Applicant: Dragan Zivotic, Palm Bay, FL (US)

(72) Inventor: Dragan Zivotic, Palm Bay, FL (US)

(21) Appl. No.: 18/618,831

(22) Filed: Mar. 27, 2024

Related U.S. Application Data
(60) Provisional application No. 63/492,345, filed on Mar. 27, 2023.

(51) Int. Cl. G09B 19/24; F41B 15/00

(52) U.S. Cl. CPC G09B 19/24; F41B 15/00

(57) ABSTRACT

A knife throwing training apparatus for training throwing knives is provided. The knife throwing training apparatus may include a main body, finger portions, and at least one thumb portion. The main body may have first side and a second side opposite the first side. The main body may also include a handle portion and a blade portion. The plurality of finger portions may be formed on the first side and/or on the second side of the main body. The thumb portion(s) may be formed on the first side and/or on the second side of the main body. The plurality of finger portions may be positioned adjacent to one another and may be positioned at the handle portion and/or at the blade portion. The handle portion and the blade portion may comprise a monolithic unit, a pivotal attachment with one another, and/or be connected with one another.

### RELATED APPLICATIONS

This application claims priority under 35 U.S.C. § 119 (e) of U.S. Provisional Patent Application Ser. No. 63/492,345 (Attorney Docket No. 6601.00002) filed on Mar. 27, 2023 and titled KNIFE THROWING TRAINING APPARATUS. The content of this application is incorporated herein by reference except for where it conflicts with the content herein.

### FIELD OF THE INVENTION

The present invention relates to throwing knives and, more specifically, to a knife throwing training apparatus, a knife throwing training kit, and a method to teach users how to properly throw knives.

### BACKGROUND OF THE INVENTION

The use and interest in throwing knives has steadily grown over time such that people of frequently drawn to throwing knives as a hobby and for some utility. However, the prior art has failed to provide for an effective training option for those new to throwing knives and or those looking to further practice throwing knives. Traditional throwing knives, while functional, have been observed to be suboptimal for training purposes or effective for use as a throwing knife. Their design often lacks the necessary features that facilitate a smooth learning curve for beginners, and even for more experienced users, and do not provide for assistance for proper throwing knife use or technique.

For example, the prior art fail to provide for effective aid and utility with grip and grip positioning. Grip position is a large deciding factor for accurate and consistent throws of throwing knives, yet traditional throwing knives do not provide effective guidance or assistance in this regard. Improper grip of a throwing knife not only affects the accuracy and consistency of the throws but can also pose safety risks. Therefore, there is a need left by the prior art for throwing knives that provide for effective performance, practice, guidance, and ease of use, particularly in training scenarios.

This background information is provided to reveal information believed by the applicant to be of possible relevance to the present invention. No admission is necessarily intended, nor should be construed, that any of the preceding information constitutes prior art against the present invention.

### SUMMARY OF THE INVENTION

With the above in mind, embodiments of the present invention are related to a knife throwing training apparatus comprising a main body, finger portions, and at least one thumb portion. The main body may have first side and a second side opposite the first side. The main body may also include a handle portion and a blade portion. The plurality of finger portions may be formed on the first side and/or on the second side of the main body. The thumb portion(s) may be formed on the first side and/or on the second side of the main body. The plurality of finger portions may be positioned adjacent to one another and may be positioned at the handle portion and/or at the blade portion. The handle portion and the blade portion may comprise one or more of a monolithic unit, a pivotal attachment with one another, and/or a connection with one another.

### BRIEF DESCRIPTION OF THE DRAWINGS

FIG. 1 is a front perspective view of a knife of a knife throwing training apparatus according to an embodiment of the present invention.

FIG. 2 is a rear perspective view of the knife shown in FIG. 1.

FIG. 3 is a front perspective view of a knife of a knife throwing training apparatus according to another embodiment of the present invention.

FIG. 4A is a front perspective view of a folding knife of a knife throwing training apparatus according to another embodiment of the present invention.

FIG. 4B is a front perspective view of a hunting knife of a knife throwing training apparatus according to another embodiment of the present invention.

FIG. 5 is a perspective view of kit for use in connection with a folding knife of a knife throwing training apparatus according to an embodiment of the present invention.

FIG. 6 is an environmental view of a person using a knife shown in FIGS. 1 and 2.

### DETAILED DESCRIPTION OF THE INVENTION

The present invention will now be described more fully hereinafter with reference to the accompanying drawings, in which preferred embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Those of ordinary skill in the art realize that the following descriptions of the embodiments of the present invention are illustrative and are not intended to be limiting in any way. Other embodiments of the present invention will readily suggest themselves to such skilled persons having the benefit of this disclosure. Like numbers refer to like elements throughout.

Although the following detailed description contains many specifics for the purposes of illustration, anyone of ordinary skill in the art will appreciate that many variations and alterations to the following details are within the scope of the invention. Accordingly, the following embodiments of the invention are set forth without any loss of generality to, and without imposing limitations upon, the invention.

In this detailed description of the present invention, a person skilled in the art should note that directional terms, such as “above,” “below,” “upper,” “lower,” and other like terms are used for the convenience of the reader in reference to the drawings. Also, a person skilled in the art should notice this description may contain other terminology to convey position, orientation, and direction without departing from the principles of the present invention.

Furthermore, in this detailed description, a person skilled in the art should note that quantitative qualifying terms such as “generally,” “substantially,” “mostly,” and other terms are used, in general, to mean that the referred to object, characteristic, or quality constitutes a majority of the subject of the reference. The meaning of any of these terms is dependent upon the context within which it is used, and the meaning may be expressly modified.

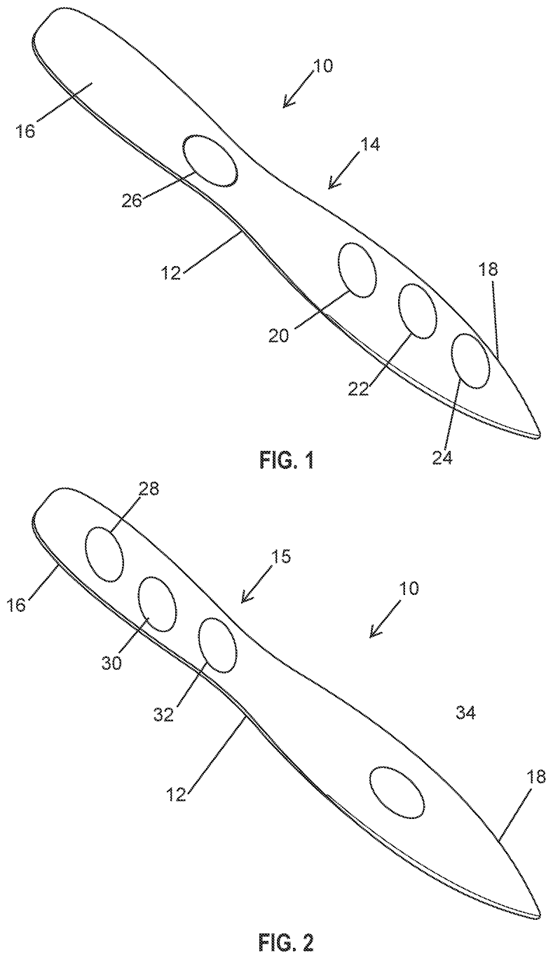

An embodiment of the invention, as shown and described by the various figures and accompanying text, provides a knife throwing training apparatus 10, which will be described in greater detail. As perhaps best illustrated in FIGS. 1 and 2, the knife throwing training apparatus 10 includes a knife main body 12 (or also referenced herein as a main body). FIG. 1 illustrates the front 14 of the knife main body 12. FIG. 2 illustrates the rear 15 of the knife main body 12.

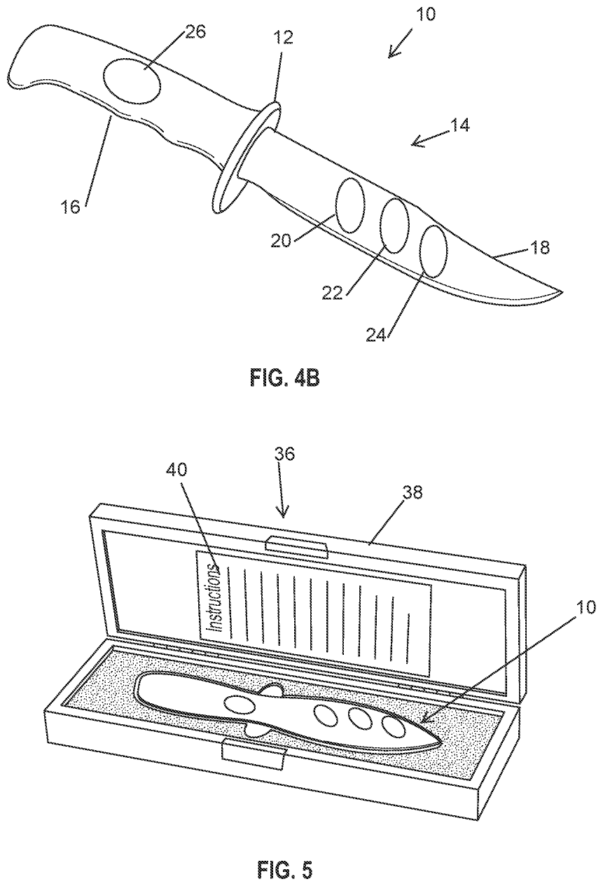

The knife main body 12 may illustratively have a handle 16. The knife main body 12 may further illustratively have a knife blade portion 18. The knives illustrated in FIGS. 1 and 2 are shaped as throwing knives, as may be understood by those skilled in the art after having the benefit of reading this disclosure. The knife blade portion 18 illustrated in the knives of FIGS. 1 and 2 preferably have sharpened edges and a sharpened tip. Although throwing style knives are illustrated in FIGS. 1 and 2, the present invention contemplates that the knife throwing training apparatus 10 may be used with any type of knife such as, for example, the folding knife illustrated in FIG. 4A and the hunting knife illustrated in FIG. 4B. The knives illustrated and discussed herein are not meant to be limiting in nature and those skilled in the art will appreciate that the present invention can be used in connection with any type of knife such as, for example, a kitchen knife (to include a chef's knife, a pairing knife, a utility knife, a boning knife, a break knife, a carving knife), a combat knife, a fighting knife, a ka bar, a bowtie knife, a pocket knife, a survival knife, or any other type of knife that may be now known or later known. In other words, the present invention can be incorporated into any type of knife while still accomplishing the goals, features and objectives thereof.

The knife main body 12 may also include a handle 16 or a handle portion. The handle 16 of the knife main body 12 is meant to be grasped by a user and is positioned opposite the knife blade portion 18. In the embodiments of the knife throwing training apparatus 10 illustrated in FIGS. 1 and 2, the handle 16 and the knife blade portion 18 may be integrally formed as a monolithic unit. Those skilled in the art will appreciate, however, that the handle 16 and the knife blade portion 18 may also be separate pieces that are connected to one another. For example, as illustrated in FIG. 4A, the embodiment of the knife throwing training apparatus 10 being provided by a folding knife includes a handle 16 and a knife blade portion 18 that are two distinct units and that are pivotally connected to one another using a pin. The pin illustratively passes through a portion of the handle 16 and a portion of the knife blade portion 18.

In the embodiment of the invention illustrated in FIG. 4B, the knife throwing training apparatus 10 is provided by a hunting style knife. The hunting style knife illustrated in FIG. 4B includes a handle 16 and a knife blade portion 18 that are connected to one another. The handle 16 and the knife blade portion 18 may be two separate portions that are connected to one another. Alternatively, a portion of the handle 16 and the knife blade portion 18 may be integrally formed as a monolithic unit and the handle 16 may be formed over a portion of the monolithically formed unit.

Those skilled in the art will appreciate that the knife throwing training apparatus 10 according to embodiments of the present invention are able to be thrown with either the left hand of the user or the right hand of the user. In the embodiment of the knife throwing training apparatus 10 illustrated in FIG. 4B, however, based on the type of knife, i.e., a hunting knife, the configuration that is illustrated is for a left handed user, i.e., a user that will be throwing the knife with their left hand. This is because when grasped by the user's left hand, the palm of the user would be adjacent to the dull portion of the knife blade portion 18. In order for the knife illustrated in FIG. 4B to be used by a right handed user, this particular type of knife would include additional finger portions on the opposite side of the blade so that when the user grasps the knife blade portion 18 with their right hand, it would not have the user's palm adjacent the sharp portion of the knife blade. This is possible with any type of knife that has a sharpened long surface.

Referring now back to FIGS. 1 and 2, additional details of the knife throwing apparatus are now provided. Referring now specifically to FIG. 1, the front 14 of the main body 12 of the knife throwing training apparatus 10 is shown. As illustrated, the front 14 of the main body 12 may include a front first finger portion 20, a front second finger portion 22 and a front third finger portion 24. The front first finger portion 20, the front second finger portion 22 and the front third finger portion 24 are positioned on the knife blade portion 18 of the main body 12 and, more specifically, on the front of the knife blade portion 18. The front 14 of the main body 12 may further include a front thumb portion 34. The front thumb portion 34 is illustratively positioned on the handle 16 of the main body 12 and, more specifically, on the front of the handle 16.

Referring now specifically to FIG. 2, the rear 15 of the main body of the knife throwing training apparatus 10 is shown. As illustrated, the rear 15 of the main body 12 may include a rear first finger portion 28, a rear second finger portion 30 and a rear third finger portion 32. The rear first finger portion 28, a rear second finger portion 30 and a rear third finger portion 32 are positioned on the handle 16 of the main body 12 and, more specifically on the rear of the handle 16. The rear 15 of the main body 12 may also include a rear thumb portion 34. The rear thumb portion 34 is illustratively positioned on the knife blade portion 18 and, more specifically, on the rear of the knife blade portion 18.

When using the knife throwing training apparatus 10 according to the present invention, the user may select whether to throw the knife main body 12 by primarily grasping the knife blade portion 18 or by primarily grasping the handle 16. FIG. 1 illustrates a configuration of the knife throwing training apparatus 10 according to an embodiment of the present invention configured in a manner where the user has selected to throw the knife main body 12 by primarily grasping the knife blade portion 18. This will be explained in greater detail below. FIG. 2 illustrates a configuration of the knife throwing training apparatus 10 according to an embodiment of the present invention where the user has selected to throw the knife main body 12 by primarily grasping the handle 16 of the main body 12. This will be explained in greater detail below.

Referring to FIG. 1, when the user has selected to throw the knife throwing training apparatus 10 by primarily grasping the knife blade portion 18, the user's forefinger is to be positioned to partially, substantially, or completely cover the front first finger portion 20. The user's middle finger is to be positioned to partially, substantially, or completely cover the front second finger portion 22. The user's ring finger is to be positioned to partially, substantially, or completely cover the front third finger portion 22. The user's thumb, however, is to be positioned to partially, substantially, or completely cover the rear thumb portion 34. Accordingly, the knife blade portion 18 is primarily grasped by three of the four fingers used to grasp the knife throwing training apparatus 10 and the remaining finger (the user's thumb) is positioned on an opposite side of the main body 12.

Referring to FIG. 2, when the user has selected to throw the knife throwing training apparatus 10 by primarily grasping the handle 16, the user's forefinger is to be positioned to partially, substantially, or completely cover the rear first finger portion 28. The user's middle finger is to be positioned to partially, substantially, or completely cover the rear second finger portion 30. The user's ring finger is to be positioned to partially, substantially, or completely cover the rear third finger portion 32. The user's thumb, however, is to be positioned to partially, substantially, or completely cover the front thumb portion 26. Accordingly, the handle 16 is primarily grasped by three of the four fingers used to grasp the knife throwing training apparatus 10 and the remaining finger (the user's thumb) is positioned on an opposite side of the main body 12.

A user may select whether to throw the knife throwing training apparatus 10 by grasping primarily the handle 16 or primarily the knife blade portion 18 based on many factors. The primary factor to be used in determining whether to grasp the knife throwing training apparatus 10 by primarily the handle 16 or by primarily the knife blade portion 18 is the distance that the user is standing from the target. In some cases, however, the user may simply have a preference as to which end of the knife main body 12 to grasp. In other instances, the user may case a particular rate of rotation of the knife throwing training apparatus 10 when thrown and the user may, based on skill level, be able to control the rate of rotation and, based on the rate of rotation, may then decide whether to grasp the knife throwing training apparatus 10 primarily by the handle 16 or primarily by the knife blade portion 18. As users use the knife throwing training apparatus 16 more, the user will more readily be able to determine which end of the knife main body 12 to use when throwing the knife throwing training apparatus 10.

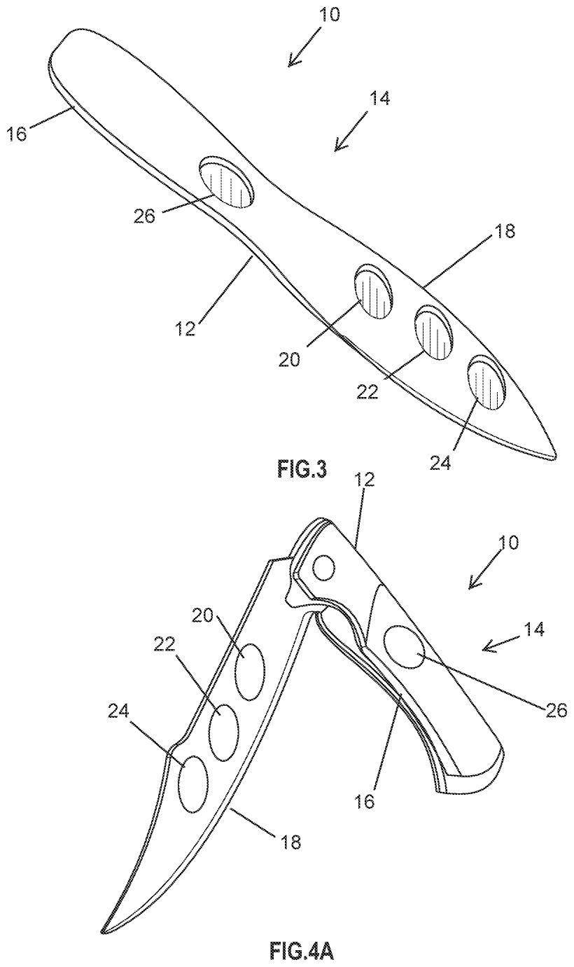

Referring now more specifically to FIG. 3, an alternate embodiment of the knife throwing training apparatus 10 is now described in greater detail. In the embodiment illustrated in FIG. 3, the front 14 of the main body 12 of the knife throwing training apparatus 10 is shown, and the finger portions are indented into the main body 12. More specifically, the front first finger portion 20, the front second finger portion 22, the front third finger portion 24, and the front thumb portion 26 are indented into the main body 12. Accordingly, when a user engages their fingers and thumb over these portions, a portion of the user's finger and thumb will go into the indentation. Although only the front 14 of the main body 12 is illustrated in FIG. 3, those skilled in the art will appreciate that the rear 15 of the main body 12 will also include the rear first finger portion 28, the rear second finger portion 30, the rear third finger portion 32 and the rear bumper portion 34.

The indentations of the front first finger portion 20, the front second finger portion 22, the front third finger portion 24, and the front thumb portion 26 are shown as being uniformly lower than the surface of the main body. However, those skilled in the art will appreciate that each of the finger portions and the thumb portion may be provided by a gradual depression into the surface of the main body 12. In the illustrated embodiment, each of the finger portions and that some portion are shown as having sidewalls. However, in an embodiment where each of the finger portions and the bottom portion of provided by a gradual depression, such a sidewall would not be provided.

It is also contemplated that the knife throwing training apparatus 10 according to the present invention may also include a plurality of stickers and/or decals that may be positioned on a knife blade portion 18 of the main body 12 of a knife, as well as on the handle 16 of a knife. This advantageously allows a user to customize any type of knife. More specifically, a user may desire to learn how to throw a knife that is already in the user's possession. As will be discussed in greater detail below with reference to a kit 36, the present invention advantageously contemplates that such stickers/decals can be provided, along with instruction on how to apply such stickers/decals, so that a user can learn to throw any type of knife.

FIG. 5 illustrates a kit 36 according to the present invention. The kit 36 may include a knife throwing training apparatus 10, a box 38, and instructions 40 for use of the knife throwing training apparatus according to the present invention. More specifically, the knife throwing training apparatus 10 may be carried by the box 38. Further, the instructions 40 may also be carried by the box. The present invention contemplates that the instructions 40 may direct a user to access a video to provide instruction on how to properly use the knife throwing training apparatus 10 according to the present invention further.

It is also contemplated that the kit 36 of the present invention may include the above-referenced stickers/decals to be positioned on a main body 12 of the knife throwing training apparatus 10. In such an embodiment, the knife throwing training apparatus 10 may be included in the box 38 without any markings or indentations that represent the finger portions and thumb portion. The instructions 40 may be provided so that the user can properly place the stickers/decals on both sides of the handle 16 and on both sides of the knife blade portion 18 of the knife throwing training apparatus 10. Alternatively, the knife throwing training apparatus 10 may be included and have the finger portions and thumb portion, as well as inclusion of stickers/decals so that a user can learn how to properly throw a knife using the knife throwing training apparatus 10 of the present invention and can also customize a knife that may be in the user's possession using the stickers/decals.

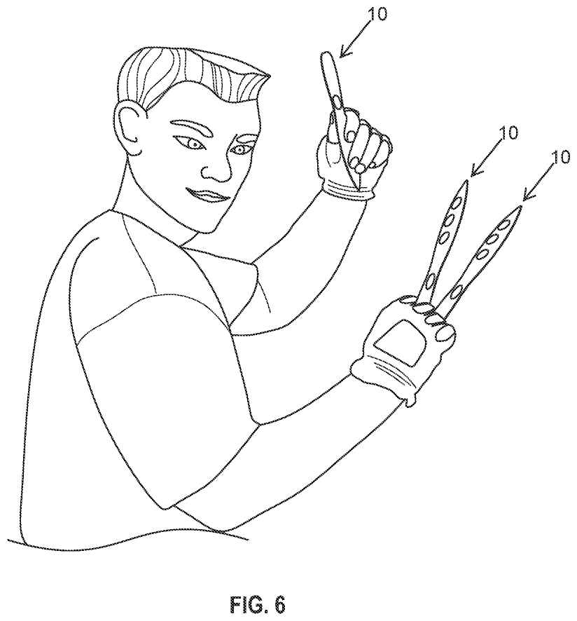

Referring now to FIG. 6, a user is shown in the action of throwing the knife throwing training apparatus 10 according to an embodiment of the present invention. As can be seen in the user's left hand, the user is primarily grasping the main body 12 of the knife throwing training apparatus 10 by the knife blade portion 18. In such a case, the user's fingers are over the finger portions on the front 14 of the main body 12 of the knife blade portion 18, and the user's thumb is on the rear thumb portion 34 on the rear 15 of the main body 12 of the knife throwing training apparatus 10 according to the present invention. The knives being shown in the user's right hand are there for illustrative purposes only.

Some of the illustrative aspects of the present invention may be advantageous in solving the problems herein described and other problems not discussed which are discoverable by a skilled artisan.

While the above description contains much specificity, these should not be construed as limitations on the scope of any embodiment, but as exemplifications of the presented embodiments thereof. Many other ramifications and variations are possible within the teachings of the various embodiments. While the invention has been described with reference to exemplary embodiments, it will be understood by those skilled in the art that various changes may be made, and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best or only mode contemplated for carrying out this invention, but that the invention will include all embodiments falling within the description of the invention. Also, in the drawings and the description, there have been disclosed exemplary embodiments of the invention and, although specific terms may have been employed, they are unless otherwise stated used in a generic and descriptive sense only and not for purposes of limitation, the scope of the invention therefore not being so limited. Moreover, the use of the terms first, second, etc. do not denote any order or importance, but rather the terms first, second, etc. are used to distinguish one element from another. Furthermore, the use of the terms a, an, etc. do not denote a limitation of quantity, but rather denote the presence of at least one of the referenced item.

1. A knife throwing training apparatus comprising:
a main body having a handle portion, a blade portion, a front, and a rear;
a front set of finger portions positioned on the front of the main body;
a front thumb portion positioned on the front the main body;
a rear set of finger portions positioned on the rear of the main body; and
a rear thumb portion positioned on the rear of the main body.

2. The apparatus of claim 1, wherein the front set of finger portions comprise a front first finger portion, a front second finger portion, and a front third finger portion.

3. The apparatus of claim 2, wherein the front first finger portion, the front second finger portion, and the front third finger portion are positioned on the blade portion.

4. The apparatus of claim 1, wherein the front thumb portion is positioned on the handle portion.

5. The apparatus of claim 1, wherein the rear set of finger portions comprise a rear first finger portion, a rear second finger portion, and a rear third finger portion.

6. The apparatus of claim 5 wherein the rear first finger portion, the rear second finger portion, and the rear third finger portion are positioned on the handle portion.

7. The apparatus of claim 1, wherein the rear thumb portion is positioned on the blade portion.

8. The apparatus of claim 1, wherein the handle portion and the blade portion are integrally formed as a monolithic unit.

9. The apparatus of claim 1, wherein the blade portion is pivotally connected to the handle portion.

10. The apparatus of claim 1, wherein front set of finger portions are indented into the blade portion on the front of the main body; wherein the rear set of finger portions are indented into the handle portion on the rear of the main body; wherein the front thumb portion is indented into the handle portion on the front of the main body; and wherein the rear thumb portion is indented into the blade portion on the rear of the main body.

11. A knife throwing training apparatus comprising:
a main body having a handle portion, a blade portion, a front, and a rear;
a front set of finger portions positioned on the front of the main body;
a front thumb portion positioned on the front the main body;
a rear set of finger portions positioned on the rear of the main body; and
a rear thumb portion positioned on the rear of the main body;
wherein the front set of finger portions include a front first finger portion, a front second finger portion, and a front third finger portion; and
wherein the rear set of finger portions include a rear first finger portion, a rear second finger portion, and a rear third finger portion.

12. The apparatus of claim 11, wherein the front first finger portion, the front second finger portion, and the front third finger portion are positioned on the blade portion.

13. The apparatus of claim 11, wherein the front thumb portion is positioned on the handle portion; and wherein the rear thumb portion is positioned on the blade portion.

14. The apparatus of claim 11, wherein the rear first finger portion, the rear second finger portion, and the rear third finger portion are positioned on the handle portion.

15. The apparatus of claim 11, wherein the handle portion and the blade portion are integrally formed as a monolithic unit.

16. The apparatus of claim 11, wherein the blade portion is pivotally connected to the handle portion.

17. The apparatus of claim 11, wherein front set of finger portions are indented into the blade portion on the front of the main body; wherein the rear set of finger portions are indented into the handle portion on the rear of the main body; wherein the front thumb portion is indented into the handle portion on the front of the main body; and wherein the rear thumb portion is indented into the blade portion on the rear of the main body.

18. A kit for throwing knife training comprising:
a box;
a throwing knife training apparatus to be carried by the box and comprising:
a main body having a handle portion, a blade portion, a front, and a rear;
a front set of finger portions positioned on the front of the main body;
a front thumb portion positioned on the front the main body;
a rear set of finger portions positioned on the rear of the main body; and
a rear thumb portion positioned on the rear of the main body;
wherein the front set of finger portions comprise a front first finger portion, a front second finger portion, and a front third finger portion; and
wherein the rear set of finger portions comprise a rear first finger portion, a rear second finger portion, and a rear third finger portion.

19. The kit of claim 18, wherein the front first finger portion, the front second finger portion, and the front third finger portion are positioned on the blade portion; wherein the front thumb portion is positioned on the handle portion; wherein the rear first finger portion, the rear second finger portion, and the rear third finger portion are positioned on the handle portion; wherein the rear thumb portion is positioned on the blade portion.

20. The kit of claim 18, wherein front set of finger portions are indented into the blade portion on the front of the main body; wherein the rear set of finger portions are indented into the handle portion on the rear of the main body; wherein the front thumb portion is indented into the handle portion on the front of the main body; and wherein the rear thumb portion is indented into the blade portion on the rear of the main body.
